(19) United States
(12) Patent Application Publication
(10) Pub. No.: US 2006/0104792 A1
(43) Pub. Date: May 18, 2006

(54) Manipulator with a line arrangement leading to the processing tool

(76) Inventor: Stefano Giuliano, Gerlingen (DE)

Correspondence Address: Gregory D. DeGrazia;Howard & Howard Attornes PC, 39400 Woodward Avenue, Bloomfield Hills, MI, 48304-5151, US

(21) Appl. No.: 10/713,894

(22) Filed: Aug. 15, 2002

(30) Foreign Application Priority Data
Aug. 16, 2001 (DE) 101 39 088.2

(51) Int. Cl. H02K 16/00

(52) U.S. Cl. 414/744.3

(57) ABSTRACT

The interior part of the atomizer of a spray-painting robot is rotatably supported in an outer part that is rigidly connected to the drive flange of the robot in order to decouple the supply lines of the atomizer which lead through the wrist joint of the robot from the rotational movements of the robot axis.

The invention pertains to an automatically controlled multi-axis manipulator for a processing tool according to the preamble of Claim 1. The invention pertains, in particular, to a robot or another multi-axis manipulator for the mass-production spray-painting or coating of car bodies, for example, with a rotary atomizer or a pneumatic atomizer or another application tool, wherein supply hoses for the coating medium and rinsing media and other auxiliary media, in particular, compressed air, as well as electric, pneumatic and, if applicable, optical signal lines for sensors, actuators, valve controls, etc., pass through the manipulator to the application device. This line arrangement usually leads from the outside through the “axes,” i.e., the component members that are realized in the form of hollow shafts and the corresponding joints of the manipulator required for realizing the kinematically complex movements during the painting process. Suitable robotic and wrist joint structures for this purpose are known (U.S. Pat. No. 4,904,148, U.S. Pat. No. 4,708,580, etc.).

For example, the three axes of the wrist joint of a spray-painting robot (which are usually referred to as axis 4, axis 5 and axis 6) can turn relative to one another at high speed during the painting process. If the angular ranges of the three axes are added up, the turning angle that is respectively limited by the hoses or other lines may be approximately ±540° in the observed example. Within this large angular range, the lines not only become bent, but also are subjected to high torsional loads that can result in damage if no measures are taken to compensate for the torsional stresses.

In order to compensate for the torsional stress, it is common practice to connect the hose parts that turn relative to one another at the various robot axes by means of rotary leadthroughs. When connecting the parts of a single hose, a coaxial central bore is sufficient. However, leadthroughs in the form of ring channels that are sealed with sliding ring seals are required for additional hoses. However, these single-channel or multi-channel leadthroughs are unable to prevent the lines from becoming entangled with other lines that cannot be easily arranged in a rotatable fashion, for example, electric lines and, in particular, optical fibers. Despite these leadthroughs, only limited turning angles of the wrist joints or other component members of the manipulator are permitted. Among other things, this results in undesirable reversals in the direction of rotation of an atomizer during the painting process. Valuable production time is lost during the reorientation, where it may also be required to shut off the spray jet with associated undesirable “overspray” (spraying past the workpiece) in order to prevent painting flaws.

Another disadvantage of conventional rotary leadthroughs is that significant torque may occur which, under certain circumstances, cannot be overcome such that the corresponding torsional forces are not compensated but rather must be absorbed by the line arrangement.

Another problem is that the paint or another coating material must be frequently changed. This means that the corresponding hose lines must be flushed. Since conventional leadthroughs contain large dead spaces, the flushing of these leadthroughs is time- and labor-intensive.

In certain applications, the required seal construction of conventional leadthroughs also results in high spatial requirements and heavy weight. This is particularly undesirable in spray-painting robots.

Similar problems may also arise in other manipulators for processing tools that are connected to hose lines and/or other lines.

Consequently, the invention is based on the objective of disclosing a manipulator in which damaging torsional loads on the line arrangement of the processing tool to be moved can be prevented without limiting the turning angle of the component members.

This objective is realized with the characteristics of the independent claim.

According to the invention, a central leadthrough for all hoses and other lines leading to the processing tool is realized, wherein this central leadthrough is not dependent on the number and function of the hoses or the like and decouples the entire line arrangement from the rotational movements of the manipulator component members. In the case of atomizers, the media emerging from the atomizer, e.g., paint and air, are also decoupled from the rotational movements with the aid of this leadthrough.

The invention makes it possible to eliminate the turning angle limitation required thus far, for example, that of the wrist joint of a robot. The “axes” of the wrist joint and, if applicable, other “axes” of the manipulator are able to turn endlessly in one direction without subjecting the line arrangement leading through these axes to significant torsional loads, since the line arrangement, at most, bends. In a program-controlled moving sequence over the workpieces, a reorientation with associated standstill times and the above-mentioned disadvantages is consequently no longer required. Since, according to the invention, the hose lines and other lines are no longer subjected to significant loads, they also have a longer service life and a superior operational reliability due to the reduced risk of damage.

If any torque is generated due to the required pivot bearings and, if applicable, sliding ring seals, the torque is so low that it can easily be absorbed by the line arrangement. In other instances, it is practical if a thin, flexible shaft for absorbing torque is led through the component members of the manipulator parallel to the line arrangement and fixed on the rotatably supported part of the processing tool.

The part of the processing tool that is connected to the line arrangement is preferably supported in an exterior housing that may either consist of the end member of the manipulator components (robot axes) itself or of the housing of a conventional processing tool which is rigidly arranged on this end member.

Embodiments of the invention are described in greater detail below with reference to the drawing, which shows:

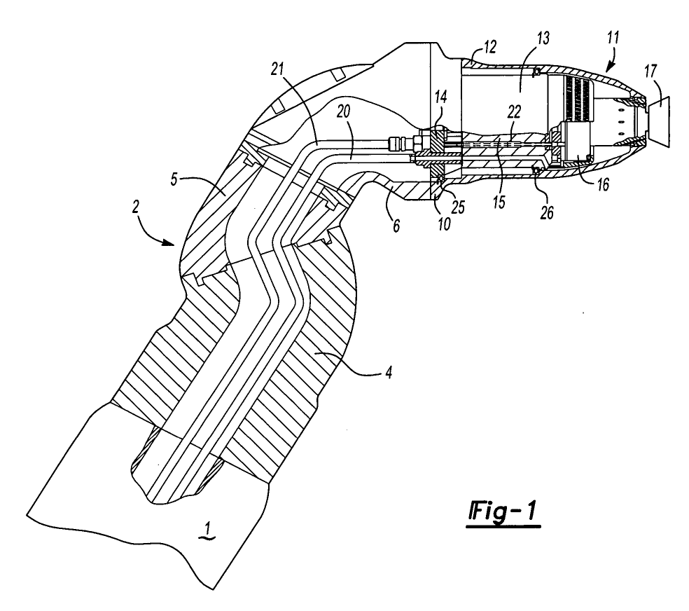

FIG. 1, the wrist joint of a spray-painting robot with a rotary atomizer;

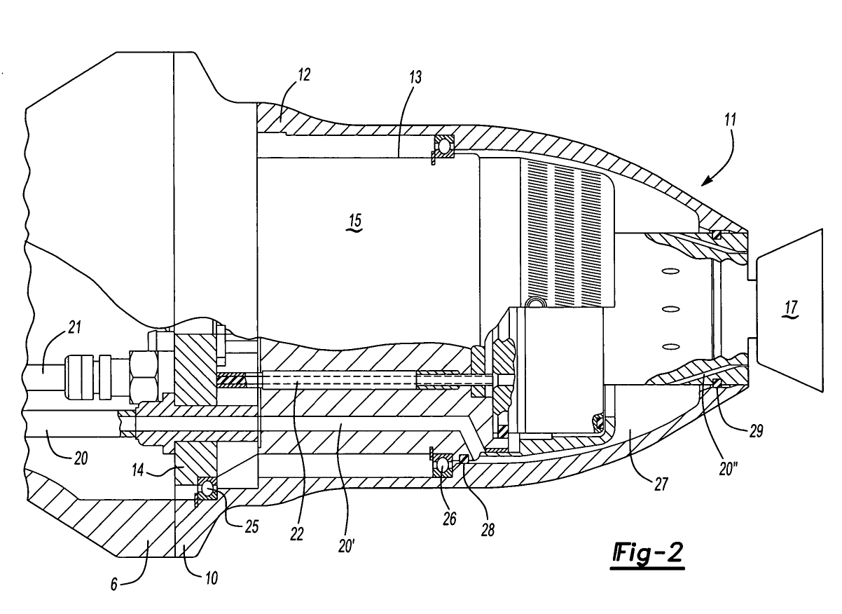

FIG. 2, an enlarged representation of the rotary atomizer shown in FIG. 1;

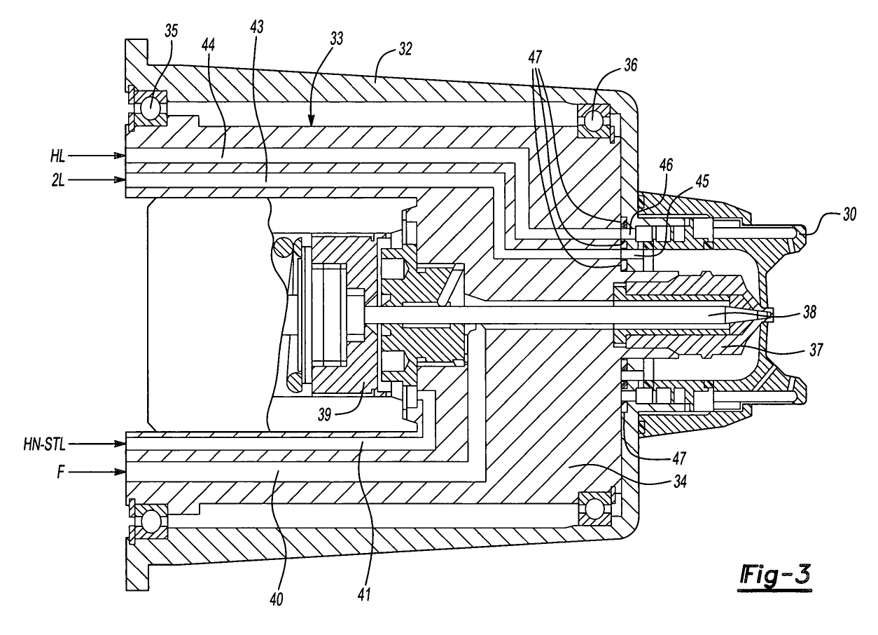

FIG. 3, a pneumatic atomizer with rotatably supported interior part;

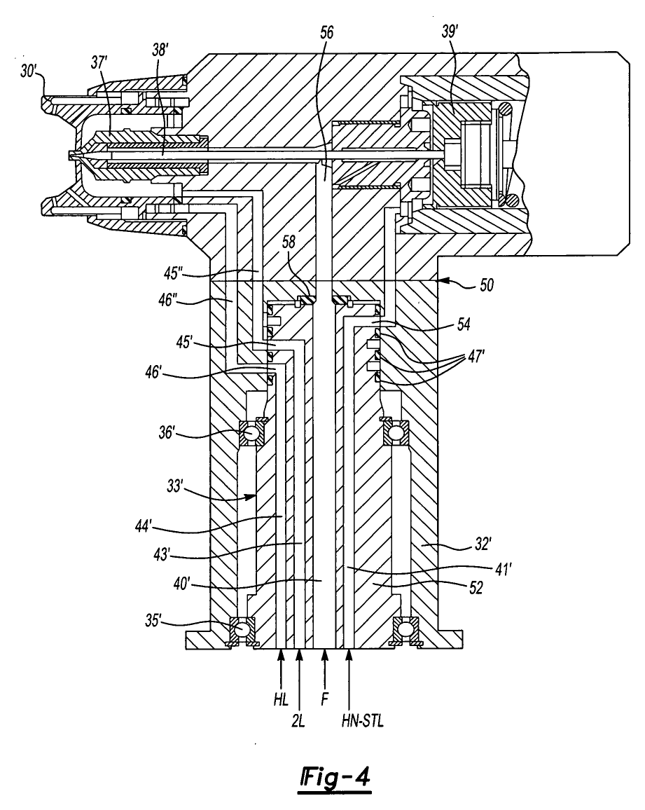

FIG. 4, another embodiment of a pneumatic atomizer with a rotatably supported interior part; and

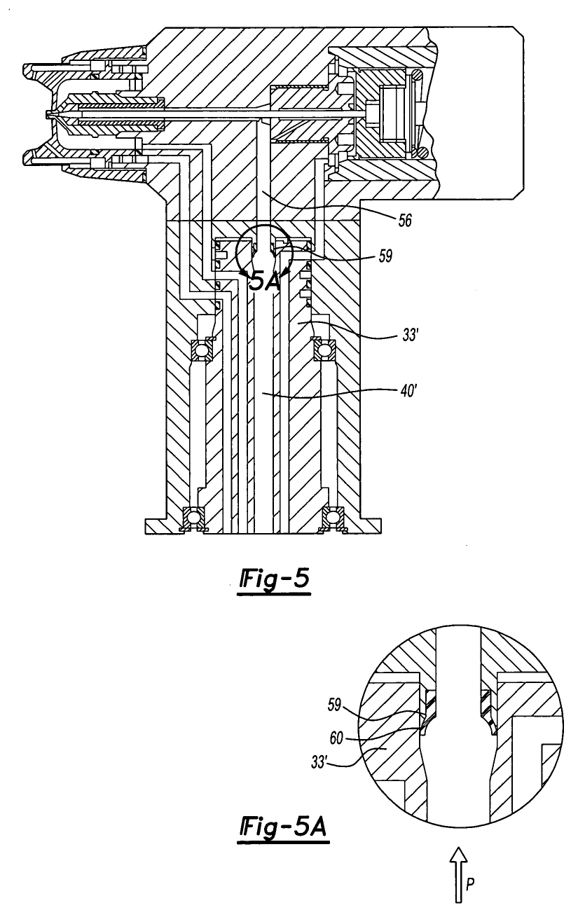

FIGS. 5 and 5A, an embodiment that is realized similarly to FIG. 4, but modified.

According to FIG. 1, a hollow wrist joint 2 of conventional design is mounted on the arm 1 of a spray-painting robot which is realized in the form of a hollow shaft, with said wrist joint conventionally containing three “axes” 4, 5 and 6 that can be turned relative to one another and are respectively driven by a motor (not shown). In this case, the “axis” 4 can be turned relative to the arm 1 about its longitudinal axis. The outer flange ring 10 of a high-speed rotary atomizer 11 of conventional modular design (e.g., according to DE 43 06 800 A1) is fixed to the end of the “axis” 6 that forms the end member of the robot. The rotary atomizer consists of an outer housing 12 and an interior part that is generally designated by reference number 13 and comprises an inner flange part 14, the valve block 15, the air turbine 16 and the atomizer cone 17 fixed to the rotatary turbine shaft. Various hoses and lines for paints, solvents, air, signals, etc., which are generally represented by line 20 that serves as an air conduit extend through the arm 1 and the wrist joint 2, where said hoses and lines are connected to and fixed to the interior part 13 of the rotary atomizer. This figure also shows an optical fiber 21 that is connected to an optical sensor for detecting the rotational speed of the turbine via a rigid optical fiber rod 22.

The entire interior part 13 is supported in the outer housing 12 such that it can turn about the longitudinal axis of the atomizer 11, in this case, the rotational axis of the atomizer cone 17 described below with reference to FIG. 2. The outer housing 12 is rigidly fixed to the “axis” 6 of the wrist joint 2 by means of the outer flange ring 10 such that its movements are transmitted to the atomizer cone 17 via the pivot bearings 25, 26.

As described above, the axes of motion of the robot arm participate only in the excursions of the spray jet of the atomizer cone 17, where the line arrangement 20, 21 connected to the rotary atomizer is decoupled from the resulting rotational movements of the robot axes. In order to prevent the interior part 13 from rotating as the outer housing 12 is turned by the robot axis, the interior part 13 is held in position by the line arrangement and, in particular, its hoses and/or, if applicable, a thin, flexible shaft (not shown) that is suitable for absorbing torque.

In the embodiment shown, the first pivot bearing 25 is seated between the outer flange ring 10 that is rigidly connected to the cylindrical housing 12 and that also has a cylindrical shape and the inner flange part 14 that is rigidly connected to the interior part 13 and that has the shape of a circular disk. The second pivot bearing 26 may be arranged between the cylindrical outer side of the valve block 15 and the inner wall of the housing 12, e.g., as shown in the figure.

In the described spray-painting robot, a rotary seal within the line for conveying the coating material (not shown) is not required. However, it may be practical in certain applications to form this line from parts that can be turned relative to one another within the atomizer (see FIG. 4). In any case, all connections for media that should be conveyed outwardly through the atomizer are decoupled from the rotational movements of the robot component members about their respective longitudinal axes.

High-speed rotary atomizers not only require a paint line for the coating material, but also one or more additional lines for the media to be conveyed outwardly, in particular, for the steering air that controls the sprayjet. According to the embodiment shown, the steering air can be decoupled from the rotational movements of the robot axes by means of a sealed ring channel 27 between the outer side of the interior part 13 and the inner wall of the outer housing 12. This ring channel is sealed with two sliding ring seals or other sliding seals 28 and 29 that adjoin the respective surfaces on the radially inner and outer sides. For example, these seals may consist of an elastic 0-ring in combination with a Teflon sliding ring as they are conventionally used in multi-channel leadthroughs (Deubliri GmbH). The first sliding ring seal 28 is seated adjacent to the pivot bearing 26, i.e., on the side that faces the cone 17, with the second sliding ring seal 29 seated in the vicinity of the front end of the outer housing 12, i.e., between the outer housing and the front edge of the housing of the turbine 16 which faces the cone 17. The ring channel 27 is supplied by the air channel 20′ that is connected to the line 20 and terminates on the outer side of the atomizer behind the cone 17 in the form of another ring channel 20″.

The embodiment according to FIG. 3 essentially differs from the embodiment according to FIGS. 1 and 2 only in that the processing tool arranged on the robot or another multi-axis manipulator consists of a pneumatic atomizer of conventional design and function instead of a high-speed rotary atomizer. In order to deflect the sprayjets, the air flap 30 of this atomizer is rigidly fixed, for example, on a wrist joint of the manipulator by means of its cylindrical outer housing 32. The interior part 33 of the atomizer that is decoupled from the rotational movements of the manipulator is rotatably supported in the outer housing 32, where said interior part comprises a cylindrical valve housing 34 and the paint nozzle 37 fixed to the valve housing, as well as the corresponding axially movable valve needle 38 (that is usually referred to as the main needle) and its drive 39. The two pivot bearings 35 and 36 are preferably arranged on the axial ends of the valve housing 34 between the valve housing and the inner side of the outer housing 32.

The path for the coating material F passes completely through the interior part 33 of this atomizer, from the point of connection to the paint hose leading through the manipulator, through the channel 40 and into the paint nozzle 37 along the valve needle 38. Thus, the paint path is entirely decoupled from the rotational movements of the manipulator. This also applies to the channel 41 for the main needle control air HN-STL which ends in the valve housing 34. The paths for the atomizing air ZL and the horn air HL which are also required in pneumatic atomizers initially lead into channels 43 and 44 within the rotatably supported interior part 33 and then from this interior part into ring channels 45 and 46 in the outer housing 32 that is rigidly connected to the drive flange of the manipulator, i.e., arranged stationarily relative to the interior part 33. Thus, the internal sealed leadthroughs, e.g., with sliding ring seals, which are integrated with the atomizer, are required for the atomizing air and the horn air channels. In the figure, these leadthroughs are arranged at 47, i.e., on the ring channels 45 and 46 between the end surface of the valve housing 34 on the nozzle side and the inner surface of the outer housing 37 which faces the valve housing.

FIG. 4 shows another embodiment of a pneumatic atomizer that is constructed slightly differently in comparison with the atomizer shown in FIG. 3. Here, the entire atomizing head with the air flap 30′, the paint nozzle 37′, the valve needle 38′ and its drive 39′ is rigidly connected to the outer housing part 32′ and thus to the drive flange of the manipulator at the connecting plane 50. The interior part 33′ that is rotatably supported in the outer housing part 32′ by means of the pivot bearings 35′ and 36′ consists of a connection block 52 in this case, wherein the different channels that are connected to the hoses leading through the manipulator lead through the connection block into the atomizer part that is arranged stationarily relative to these channels, i.e., into the outer housing part 32′ of the stationary atomizer part, and finally into the atomizer head. The connection block may also contain valves (not shown), electrical terminals and lines, etc.

The channels 43′ and 44′ for the atomizing air and the horn air are respectively connected to channels 45″ and 46″ in the outer housing part 32′ which continue up to the atomizer head via ring channels 45′ and 46′ and conventional sealed leadthroughs with sliding ring seals or other sliding seals 47′. At the connecting plane 50, these channels 45″, 46″ are sealed with stationary seals. Similarly, the incoming channel 41′ for the main needle control air HN-STL continues up to the valve drive 39′ via rotationally sealed ring channel 54.

Since the path for the coating material F consists of channels 40′ and 56 that can be turned relative to one another within the atomizer in this embodiment, a rotary seal for the paint channel is also required within the atomizer in this case. This rotary seal is realized in the form of the leadthrough illustrated at 58 and arranged centrally and coaxially relative to the rotational axis of the interior part 33′. The paint channel parts which are stationary relative to the decoupled interior part 33′ are mutually sealed at the connecting plane 50 similarly to the other channels.

As in the other embodiments, the paint channel of the atomizer according to FIG. 4 which contains a rotary leadthrough provides the advantage of a continuous paint path that is essentially free of dead spaces and can be easily flushed with little effort when the paint is changed, e.g.

The invention is not only suitable for spray-painting robots, but also for painting manipulators and other manipulators in which a multiple rotation of the atomizer or another processing tool is not required. The particular advantage achieved in such instances can be seen in the careful and torsion-free manipulation of the line arrangement and the resulting improvement in productivity.

However, it may also be practical in other applications to provide a mechanical interface, at which one part of the device, usually the front part, can be automatically separated from the remaining part within a processing tool, for example, for realizing an automatically controlled processing tool exchange or as a collision protection and/or overload safety. In the embodiment according to FIG. 4, the interface would preferably lie at the connecting plane 50. In the case of atomizers, the atomizer head could be exchanged for another processing tool with the aid of an automatic tool changing system, for example, another atomizing head, a measuring device or the like. Collision protection makes it possible to prevent damage when the processing tool impacts external obstacles. Overload protection is particularly desirable in those instances in which the processing tool to be moved by the manipulator is subject to processing forces and moments during its operation.

FIG. 5 shows an embodiment of a pneumatic atomizer which generally corresponds to the atomizer according to FIG. 4. However, this pneumatic atomizer differs with respect to the rotary seal for the paint-path channels 40′ and 56, which can be turned relative to one another. Instead of the leadthrough 58 according to FIG. 4, the collar or lip seal 59 which is illustrated in enlarged fashion in FIG. 5A is provided in this case.

One essential characteristic of this collar-like seal 59 which is arranged coaxially with the axis of rotation is that its annular, outwardly curved lip adjoins the wall of the paint channel 40 of the rotatably supported interior part 33′ with a slight radial prestress. This prestress of the lip seal that, for example, consists of UHMWPE (ultra-high molecular weight polyethylene) or a suitable fluorocarbon (PTFE) can be achieved with the aid of special manufacturing methods, in which the shape-retaining properties of the materials are utilized. Seals of this type have excellent sliding properties, not only when used for sealing sliding movements, but also when sealing rotational and pivoting movements. They are able to compensate for axial play and are characterized by an extremely low wear, and thus a long service life. They provide the additional advantage that an increase in pressure p (FIG. 5A) in the sealed channel increases the pressing force exerted upon the lip seal and consequently the sealing effect. In addition, the seal shown in the figure is relatively free of dead spaces and can be correspondingly well flushed. Such seals with lips that are prestressed radially outwardly are not only suitable for use in the rotational decoupling described in this document, but also in other instances in which parts that are displaced, turned and/or pivoted relative to one another must be mutually sealed.

As described above, at least the part of the processing tool, on which the line arrangement is fixed, is supported such that it can be turned relative to the first component member of the manipulator. The described embodiments, in which parts of the atomizer can be turned relative to one another, e. g., the interior part that can be turned relative to the outer housing, may also be modified within the scope of the invention in that the rotation of the entire atomizer takes place relative to the mechanical interface (mounting flange) of the manipulator.

1. Automatically controlled multi-axis manipulator for a processing tool, comprising at least a first and a second, in particular, hollow component members, wherein said first member, on which said processing tool to be moved by said manipulator is arranged, can be turned relative to said second member, and with a line arrangement that leads to said processing tool on or through the component members and is fixed on a part of said processing tool, wherein said part of said processing tool on which said line arrangement is fixed is supported in a rotatable fashion relative to the said first component member.

2. The manipulator according to claim 1, wherein said part of said processing tool on which said line arrangement is fixed is rotatably supported in an outer housing that is rigidly connected to said first component member.

3. The manipulator according to claim 1, wherein said line arrangement leading to processing tool contains supply hoses for at least one of liquid, gaseous media, and signal lines.

4. The manipulator according to claim 1, comprising a flexible shaft for absorbing torque leads through said component members parallel to said line arrangement and fixed on said rotatably supported part of said processing tool.

5. The manipulator according to claim 2, wherein said component members form a wrist joint of a robot.

6. The manipulator according to claim 5, wherein said processing tool consists of an atomizer or another application device that is moved by said robot, and said interior part of said processing tool which is connected to said line arrangement is rotatably supported in said outer housing of said atomizer or the like which is rigidly connected to said wrist joint of said robot.

7. The manipulator according to claim 6, comprising an annular ring for a medium to be conveyed through the processing tool is formed between the outer side of said interior part of said processing tool which is connected to said line arrangement and its outer housing that is rigidly connected to the first component member, wherein said ring is limited by sliding seals that are seated between the inner side of said outer housing and the outer side of said interior part and adjoin said housing and said interior part.

8. The manipulator according to claim 7, comprising a sealed rotary leadthrough provided within said processing tool for at least one line for a medium to be conveyed outwardly through said processing tool, wherein said medium is conveyed through at least one of a central channel that extends along a central axis of said processing tool and through a ring channel.

9. The manipulator according to claim 8, comprising at least one additional rotary leadthrough provided for at least one line that terminates in the processing tool.

10. The manipulator according to claim 9, wherein said processing tool is supported on a mechanical interface of said wrist joint of a robot, and is rotatable in its entirety relative to this interface.
